(19) United States
(12) Patent Application Publication
(10) Pub. No.: US 2015/0109180 A1
(43) Pub. Date: Apr. 23, 2015

(54) EXTENSIBLE AND RECONFIGURABLE ANTENNA

(71) Applicant: SYMBOL TECHNOLOGIES, INC., SCHAUMBURG, IL (US)

(72) Inventors: MARK W. DURON, East Patchogue, NY (US); DANIELLA N STRAT, SOUND BEACH, NY (US)

(73) Assignee: SYMBOL TECHNOLOGIES, INC., Schaumburg, IL (US)

(21) Appl. No.: 14/059,532

(22) Filed: Oct. 22, 2013

(51) Int. Cl. H01Q 9/40

(52) U.S. Cl. CPC H01Q 9/40
USPC 343/791

(57) ABSTRACT

An extendable and reconfigurable antenna apparatus includes at least one conductive monopole antenna element. An extended antenna element is provided including a junction. A conductive tube is mechanically coupled to the extended antenna element by an insulating coupler to form an assembly. Placement of the assembly over the monopole antenna element converts the monopole antenna element into a center conductor of a coaxial transmission line electrically coupled to the extended antenna element at the junction.

### BACKGROUND

A trend in enterprise systems is to provide modularization in order to allow interchangeability of functions. For example, Radio Frequency Identification (RFID) readers obtain information about objects in their environment, and it is desired to transmit this information to a central server. Several different communication protocols (e.g. Wi-Fi™, Bluetooth™, etc.) can be used to accomplish this, typically with each enterprise desiring to use their own home communication system. In addition, each enterprise may wish to upgrade its communication system in the future.

Therefore, it would be desirable to provide an RFID reader that can have interchangeable communication modules, in order to economically satisfy the communication requirements of each enterprise. One solution to this problem is to provide interchangeable communication modules that can be readily accepted by a universal RFID reader. However, it may still be quite expensive to provide complete self-contained communication modules, particularly when these communication modules could share components with each other. Therefore, an RFID reader may contain common components that can be shared between communication modules (e.g. processor, memory, antenna, etc.) such that each module only needs to supply its proper operational frequency and protocol components. Of course, it should be recognized that antenna systems still need to properly operate to support multiple frequency bands with various existing operating modes.

Accordingly, there is a need to address the issue of changing an antenna configuration to suit different communication modules.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a cross-sectional side view of an antenna structure, in accordance with some embodiments of the present invention.

FIG. 2 is a cross-sectional side view of another antenna structure, in accordance with some embodiments of the present invention.

FIG. 3 is a cross-sectional side view of yet another antenna structure, in accordance with some embodiments of the present invention.

FIG. 4 is a cross-sectional perspective view of the antenna structure of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a technique to extend and reconfigure an existing antenna. In particular, although extending antennas are known, the present invention differs by turning an unextended antenna element into a coaxial feed for an extended antenna. Specifically, an existing rod monopole antenna element can become the center conductor of a hard line coaxial cable to extend the antenna to an extended surface. This new surface can contain any type of antenna, or be the new antenna itself, such as the case for a slot antenna. The present invention allows an additional fascia or upgrade to be added over a pre-existing antenna and fascia to extend it out to the new fascia. Once extended, the new antenna site can be the same as the older site or any other type of antenna on the new fascia surface. Although, the invention as described herein uses an RFID system as an example, it should be recognized that the present invention is equally applicable to other frequency bands and services.

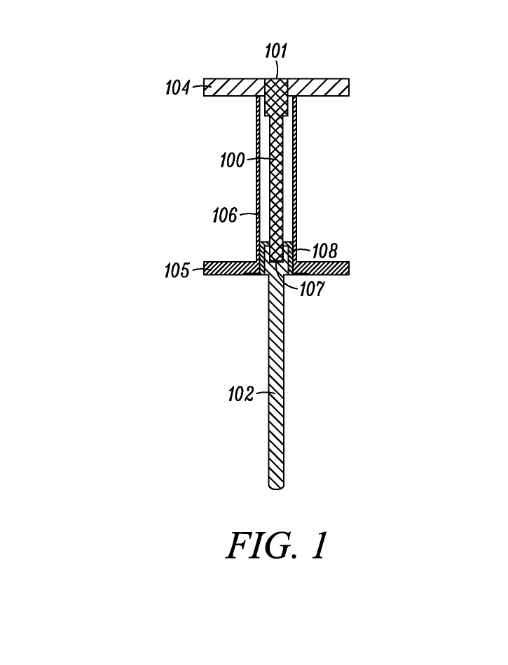

FIG. 1 is a cross-sectional side view of a monopole type antenna structure, in accordance with the present invention. Such an antenna structure can be used in various wireless communication devices. Although a monopole structure is shown in this example, it should be recognized that the present invention is applicable to other antenna types. As shown, the monopole antenna structure includes a substantially straight element 100 extending out from a fascia 104 of a communication device. In this example, the fascia is made of a non-conductive material. However, the fascia could be made of a conductive material to form a ground plane if an insulator (not shown) is provided between the straight element 100 and the ground plane (e.g. 104). As is known in the art, the antenna element 100 has an electrical length of one-quarter wavelength of the operating frequency of the communication device, and is fed an electrical signal at an electrical feed point 101. As is also known in the art, the monopole antenna can include tuning components (not shown) in order to tune or configured the antenna for the operating frequencies of the communication device.

In accordance with the present invention, the monopole antenna 100 can be extended by means of a snap-on extended antenna element. In this example, the extended antenna element includes another substantially straight monopole element 102 mechanically coupled to a cylindrical conductive tube 106 using an insulating coupler 108. The conductive tube 106 is integrated with a ground plane that forms an extended fascia 105 of an interchangeable module for connecting to the communication device. It is envisioned that the tube 106, coupler 108, extended fascia 105, and element 102 are one assembly that can be placed over the original monopole element 100 such that the conductive tube abuts the fascia 104. It is also envisioned that the new element 102 will snap-on to the original element 100 at a junction 107, wherein the junction is configured such that the element 102 will mechanically clasp the original element 100. It should be recognized that other means to affix two electrical elements could also be used, comprising screws, clips, tabs, and the like.

The junction 107 also serves to provide an electrical connection between the elements 100, 102. In particular, the tube 106 and the original element 100 form a hard coaxial connection for the new antenna element 102 that now has an electrical feed point at the junction 107. In effect, the present invention converts the original antenna element 100 into a center conductor of a transmission line connected to an electrical feed point at the junction 107 of the new antenna element 102. If the new antenna element 102 has the same electrical length as the original element 100 the new assembly will operate at the same frequency as before. However, this is not a requirement, and the new element 102 can be configured to provide a different operating frequency for the communication device. For example, the communication device could have been originally configured for 2.4 GHz Wi-Fi™ communications using only the monopole element 100. If the communication device is then being affixed with a new module that converts communication operations from 2.4 GHz Wi-Fi™ to 5.6 GHz WiFi™, the new extended antenna assembly 106, 108, 105, 102 can be connected to the original antenna 100 as part of this module, which also provides an extended fascia 105 for the communication device.

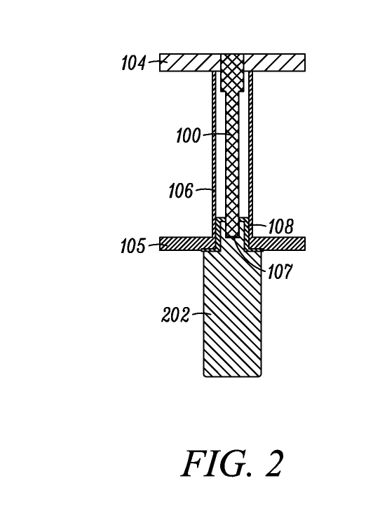

In accordance with the present invention, the extended antenna element need not be a monopole. For example, the extended antenna element can form a dipole, loop, or any other type of antenna element. In particular, the extended antenna element can be used to changing the location, frequency, length, polarization, type of an antenna apparatus. For example, referring to FIG. 2, the new extended antenna 202 could provide a dipole function in order to relocate an antenna while keeping an impedance match. In other words, the original monopole antenna element, without connection to the extended antenna element provides the same impedance match as the extended antenna element connected to the monopole antenna element.

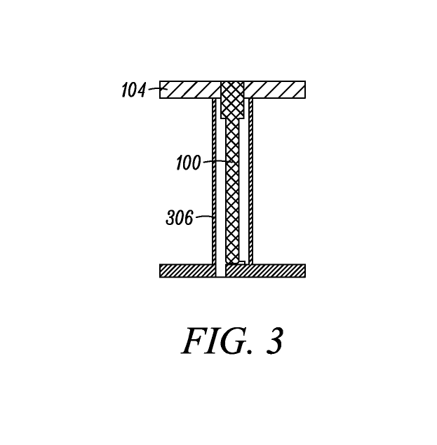

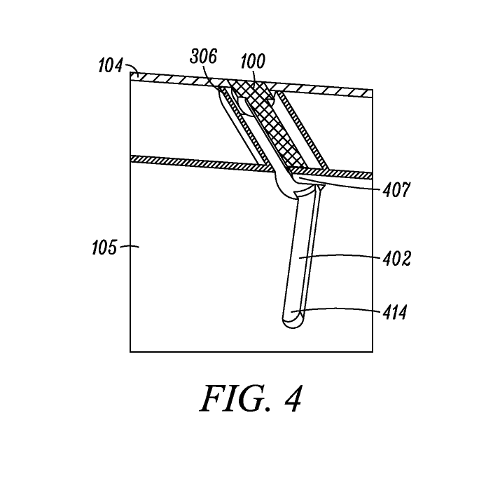

In another example, referring to FIGS. 3 and 4, the new extended antenna 402 could be a slot antenna where the monopole antenna 100 serves as a coaxial transmission line feeding one other end of slot at the junction 407, while the outer conductor (i.e. the conductive tube 306) is feeding the other one end 414 of the slot via the ground plane 105. In this case, the junction 407 can still serve as a mechanical coupling point for the assembly 306, 105 to the monopole antenna element 100, and the ground plane 105 can still serve as an extended fascia.

Advantageously, the inventive technique described herein enables a snap- over layered upgrade path to extend and/or reconfigure an antenna without adding additional cables to extend and re-connect the antenna. This can be accomplished without replacing or removing the original antenna, and without disassembly or tools. As a result, the present invention provides a simple technique to enhance modularity for reconfiguring devices.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An extendable and reconfigurable antenna apparatus, comprising:
at least one conductive monopole antenna element;
an extended antenna element including a junction;
an insulating coupler; and
a conductive tube mechanically coupled to the extended antenna element by the insulating coupler to form an assembly, wherein
placement of the assembly over the monopole antenna element converts the monopole antenna element into a center conductor of a coaxial transmission line electrically coupled to the extended antenna element at the junction.

2. The apparatus of claim 1, wherein the junction of the extended antenna element is configured to mechanically clasp and electrically connect to the monopole antenna element, wherein the junction serves as an electrical feed point of the extended antenna element.

3. The apparatus of claim 1, wherein the conductive tube is integral with a ground plane of a module, the ground plane defining an external fascia of an interchangeable module.

4. The apparatus of claim 1, wherein the monopole antenna element is mechanically coupled to a first fascia of a communication device, and wherein the conductive tube is configured to abut the first fascia upon placement of the assembly.

5. The apparatus of claim 1, wherein the extended antenna element is a monopole element.

6. The apparatus of claim 1, wherein the extended antenna element is a dipole element.

7. The apparatus of claim 1, wherein the extended antenna element is a loop antenna.

8. The apparatus of claim 1, wherein the extended antenna element is a slot antenna.

9. The apparatus of claim 1, wherein the monopole antenna element has the same impedance match as the extended antenna element upon placement of the assembly.

10. The apparatus of claim 1, wherein the extended antenna element provides a different polarization than the monopole antenna element.

11. The apparatus of claim 1, wherein the extended antenna element has the same operating frequency as the monopole antenna element.

12. A communication device including a modular extendable and reconfigurable antenna apparatus, the apparatus of the communication device comprising:
at least one conductive monopole antenna element;
an extended antenna element including a junction;
an insulating coupler; and
a conductive tube mechanically coupled to the extended antenna element by the insulating coupler to form an assembly, wherein
placement of the assembly over the monopole antenna element converts the monopole antenna element into a center conductor of a coaxial transmission line electrically coupled to the extended antenna element at the junction.

13. The device of claim 12, wherein the conductive tube is integral with an external fascia of a module that is interchangeable with the communication device.
